(19) United States
(12) Patent Application Publication
(10) Pub. No.: US 2009/0000142 A1
(43) Pub. Date: Jan. 1, 2009

(54) Drying Apparatus

(75) Inventors: John Churchill, Gloucestershire (GB); James Martin Coleman, Wiltshire (GB); James Dyson, Gloucestershire (GB); Peter David Gammack, Wiltshire (GB)

Correspondence Address: MORRISON & FOERSTER LLP, 1650 TYSONS BOULEVARD, SUITE 400, MCLEAN, VA, 22102, US

(73) Assignee: Dyson Technology Limited, Malmesbury (GB)

(21) Appl. No.: 12/159,340

(22) PCT Filed: Dec. 6, 2006
(86) PCT No.: PCT/GB2006/004552

§ 371 Date: Jun. 26, 2008

(30) Foreign Application Priority Data
Jan. 12, 2006 (GB) 0600537.5

(51) Int. Cl. F26B 3/02; F26B 25/04

(52) U.S. Cl. 34/95; 34/179

(57) ABSTRACT

A drying apparatus includes an outer case, a portion of the outer case defining a cavity, an outlet disposed at a lower end of the cavity and a liquid dispersion unit, the liquid dispersion unit comprising a collector downstream of the outlet, a liquid evaporation unit in communication with the collector and an airflow generator for exhausting evaporated liquid from the collector to the exterior of the outer case. The liquid evaporation unit includes a high frequency agitator, such as a piezo-electric device. The piezo-electric device, when in use, agitates the surface of the water, and the water can be evaporated at a low energy cost. The waste liquid is therefore removed from the drying apparatus more hygienically and economically than known prior art arrangements.

### REFERENCE TO RELATED APPLICATIONS

This application is a national stage application under 35 USC 371 of International Application No. PCT/GB06/004552, filed Dec. 29, 2006, which claims the priority of United Kingdom Application No. 0600537.5, filed Jan. 12, 2006, the contents of both of which prior applications are incorporated herein by reference.

### FIELD OF THE INVENTION

The present invention relates to drying apparatus. Particularly, the invention relates to drying apparatus including a liquid dispersion unit. More particularly, the invention relates to drying apparatus including a waste water dispersal unit for dispersing waste water from a hand dryer or laundry dryer.

### BACKGROUND OF THE INVENTION

Conventional arrangements for collecting and removing waste water from drying apparatus such as hand dryers are well known from, for example, U.S. Pat. No. 5,459,944. Waste water is collected via a duct or similar and transferred to a drip collector for subsequent manual removal. Such storage of waste water is unhygienic, may lead to the spread of bacteria and requires regular maintenance to empty the drip collector and maintain a sanitary environment.

The addition of an antibacterial water absorption sheet with a large surface area to encourage evaporation is known from JP 11-18999 A. This counters some of the problems of bacterial infestation and results in less frequent emptying of the collector. However, waste water is still present in the hand dryer for longer than is desirable, and maintenance is still required.

An alternative solution is the evaporation of the waste water through use of a thermal source. This technique is known from JP 2002-345681A. However, the use of a thermal source can be expensive and wasteful of energy. The increased thermal load on the system may also lead to thermal damage and possible injury to users.

An example of a prior art water removal system for a laundry dryer is illustrated in GB 2105451. The laundry dryer has a condensing unit which further comprises a changeover valve. Waste water from a condenser and dryer drum is removed via a drain and drain pump to the outside of the apparatus, or is stored in a condensate receiver for removal by a user. This requires either the laundry dryer to be connected to suitable plumbing in the room in which the laundry dryer is installed, or for the condensate receiver to require regular maintenance by a user. If waste water is stored in a condensate receiver, it is also unhygienic.

### SUMMARY OF THE INVENTION

It is an object of the present invention to provide drying apparatus which, in use, is able to disperse waste water more hygienically and efficiently than known prior art arrangements. It is a further object of the present invention to provide a drying apparatus which, in use, is able to disperse waste water at a low operating cost to the consumer.

The invention provides drying apparatus comprising an outer case, a portion of the outer case defining a cavity in which articles can be dried, an outlet disposed at a lower end of the cavity and a liquid dispersion unit, the liquid dispersion unit comprising a collector downstream of the outlet, a liquid evaporation unit in communication with the collector and an airflow generator for exhausting evaporated liquid from the collector to the exterior of the outer case, wherein the liquid evaporation unit comprises a high frequency agitator. By providing a high frequency agitator to evaporate the collected liquid, the liquid is evaporated to be removed from the hand dryer more economically than in known prior art arrangements.

Preferably, the high frequency agitator comprises a piezo-electric device. The piezo-electric device, when in use, agitates the surface of the water and the water can be evaporated for relatively little energy cost when compared to prior art water evaporation systems. Advantageously, no heating element is required, preventing thermal damage to the drying apparatus and possible injury to a user if a hot element is accidentally touched. Further, water can be removed from the drying apparatus quickly and efficiently, preventing the build-up of bacteria or other micro-organisms. Additionally, water can be evaporated at a rate such that when the water is exhausted from the drying apparatus, it is unnoticeable to the naked eye.

### BRIEF DESCRIPTION OF THE DRAWINGS

Further advantageous features will become apparent from the following description of embodiments of the invention which are now described with reference to the accompanying drawings in which:

FIG. 1a is a perspective view of a hand dryer according to a first embodiment of the present invention;

FIG. 1b is a side view of a hand dryer according to the first embodiment of the present invention;

FIG. 2 is a section through a hand dryer according to the first embodiment of the present invention;

FIG. 3 is a perspective view of a hand dryer according to the first embodiment of the present invention. The front portion of the outer case has been removed to show the internal workings;

FIG. 4 is an enlarged side section of a hand dryer according to the first embodiment of the present invention, showing a liquid dispersion unit in greater detail; and

FIG. 5 is a perspective view of a laundry dryer according to a second embodiment of the present invention.

### DETAILED DESCRIPTION OF THE INVENTION

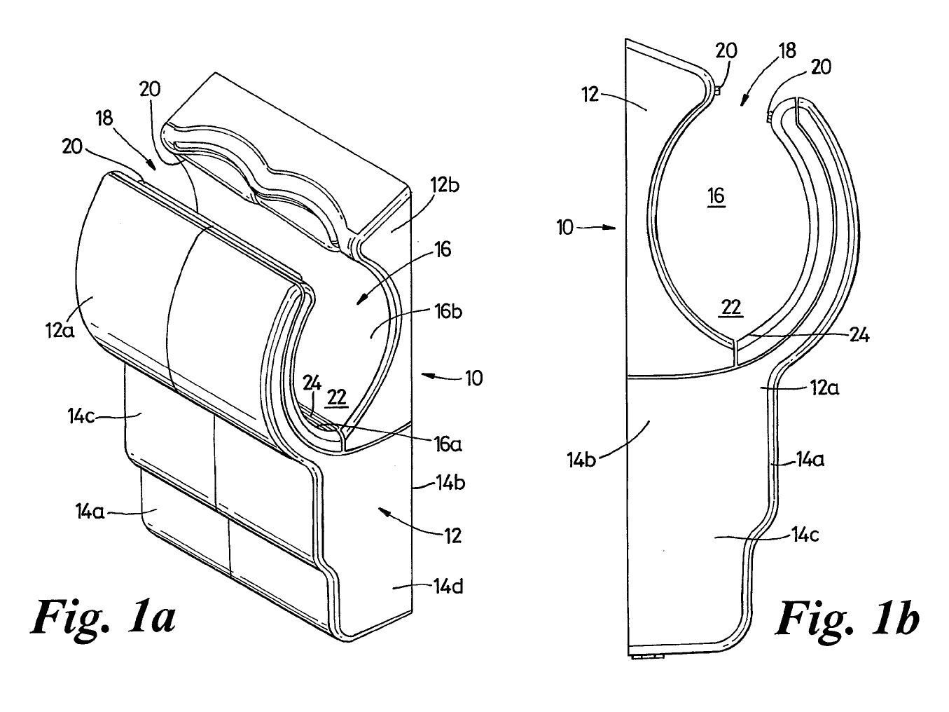

FIGS. 1a and 1b show a hand dryer 10 according to the first embodiment of the present invention. The hand dryer 10 includes an outer case 12 which comprises a front portion 12a and a rear portion 12b. The hand dryer 10 further includes a front wall 14a, a rear wall 14b, two side walls 14c and 14d, and a cavity 16. The rear portion 12b of the outer case 12 may include elements suitable for attaching the hand dryer 10 to a wall or other suitable fixture. Elements for connecting the hand dryer 10 to a power source may also be included.

The cavity 16 is defined by opposing arcuate front wall 16a and rear wall 16b. The cavity 16 is open at its upper end 18, and the dimensions of the opening are sufficient to allow hands (not shown) to be inserted easily into the cavity 16 for drying. A high-speed airflow is generated by a motor unit having a fan (not shown) and is expelled through laminar vents 20 disposed at the upper end of the cavity 16 to dry the inserted hands. This feature is not material to the present invention and will not be described any further here. The cavity 16 is open at the sides as can be seen in FIGS. 1a and 1b.

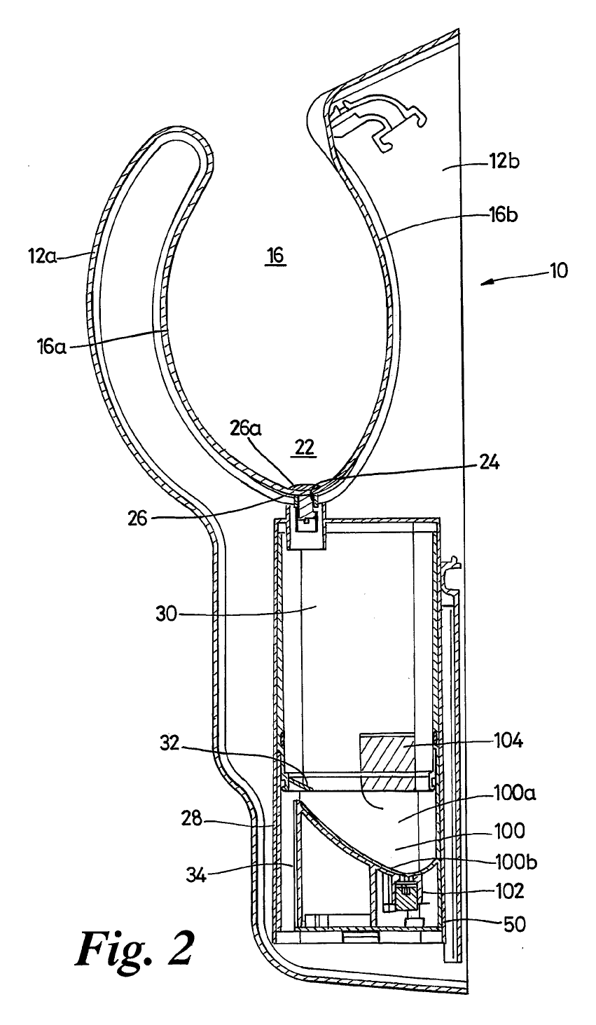

Referring to FIGS. 1a, 1b and 2, a drain channel 24 is located at the lower end 22 of the cavity 16. The drain channel 24 is delimited by the lower edges of the front wall 16a and the rear wall 16b of the cavity 16. An outlet 26 is located at one end of the drain channel 24. The drain channel 24 is sloped and the outlet 26 is located at the lowest point of the drain channel 24. The outlet 26 comprises a circular aperture with a central plug 26a. The plug 26a and outlet 26 delimit a narrow, annular portion of the outlet 26 down which water is able to flow.

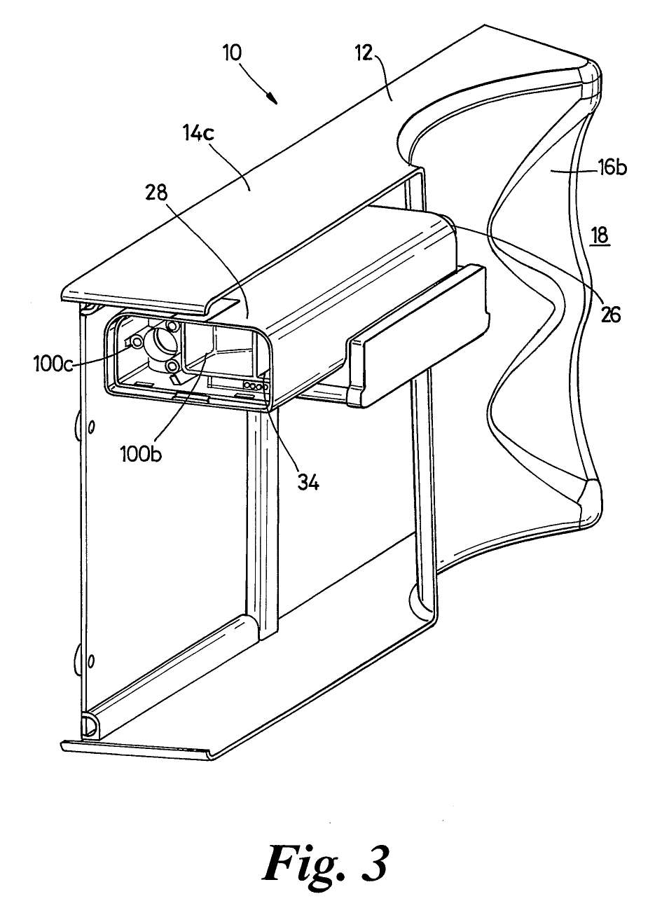

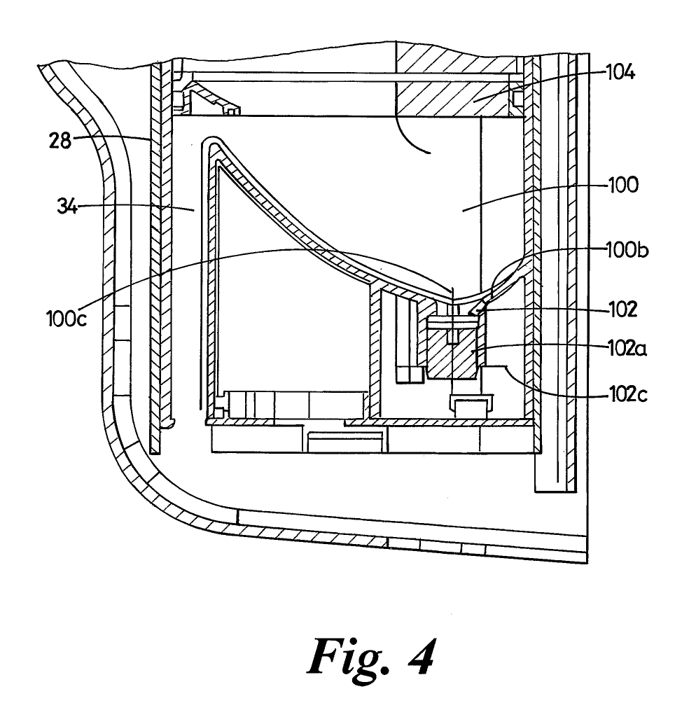

Referring to FIGS. 3 and 4, a liquid dispersion unit 28 is located inside the outer case 12 of the hand dryer 10. The liquid dispersion unit 28 is in communication with the outlet 26 by means of a passageway 30. A filter (not shown) can be placed within the passageway 30 to filter particulates from the water flow. This feature is not material to the present invention and will not be discussed here any further. At the lower end of passageway 30 is located an inlet portion 32 which provides an inlet for water flowing into the liquid dispersion unit 28. An exhaust conduit 34 located within the liquid dispersion unit 28 provides an exclusive communication path from the liquid dispersion unit 28 to the outside of the outer case 12 of the hand dryer 10.

The liquid dispersion unit 28 includes a collector 100 for collecting water from outlet 26. The collector comprises an upper end 100a and a lower end 100b. The lower end 100b of the collector 100 forms a base 100c. A high frequency agitator in the form of a piezo-electric device 102 is in communication with the base 100c. In this embodiment, the piezo-electric device 102 is located at the base 100c. Piezo-electric devices are known to develop thermal energy when in use. Therefore, a heat sink 102a is attached to the piezo-electric device 102 to dissipate generated thermal energy. This reduces thermal load on the system and extends the lifetime of the piezo-electric device 102. The piezo-electric device 102 and the heat sink 102a assembly is attached to the underside of the collector 100 by a plate 102c.

A fan 104 is located at the upper end 100a of the collector 100 and is arranged to direct an airflow into the interior of the collector 100. The airflow generated by the fan 104 is directed into the collector 100. The arrangement of the fan 104 and the shape of the lower portion 100b is such that the airflow is directed across the collector 100 to the exhaust conduit 34.

In use, water removed from a user's hands during the drying process flows down the front wall 16a and the rear wall 16b of the cavity 16 and into the drain channel 24 disposed at the lower end 22 of the cavity 16. The drain channel 24 collects and guides the water towards the outlet 26. This arrangement of the drain channel 24 allows the drain channel 24 to be accessed easily to be rinsed with fresh water or other suitable fluid in order to maintain a sanitary environment. Any dirt or debris, for example cigarettes or waste paper, will be prevented from entering the outlet 26 by the plug 26a. Therefore, dirt and debris can be prevented from unduly affecting the operation of the liquid dispersion unit 28 or blocking other parts of the apparatus.

Upon entering the outlet 26, water flows through the passageway 30 and enters the collector 100 through the inlet portion 32. The water collects at the base 100c of the collector 100. The piezo-electric device 102 is in communication with the base 100c of the collector 100. The piezo-electric device 102 is set to oscillate at a pre-determined frequency and magnitude such that sufficient vibrational energy is imparted to water molecules on the surface of the water in the collector 100 to overcome surface tension effects. The water is evaporated and forms a fine mist in the interior space of the collector 100.

The fan 104 operates to direct an airflow downwardly into the collector 100. This aids in preventing water from the collector 100 re-entering the inlet portion 32 and directs evaporated water vapour to the exhaust conduit 34. An additional effect is to create a pressure differential between the outlet 26 and the inlet portion 32 which may help in drawing the fluid down from the outlet 26.

The increase in pressure inside the collector 100 resulting from the operation of the fan 104 forces the evaporated water vapour out of the collector 100 through to the exhaust conduit 34. The evaporated water vapour then travels down the exhaust conduit 34 and is vented to the outside of the outer case 12. This process continues until all the water contained within the collector 100 is efficiently and hygienically removed by evaporation. Preferably, the airflow rate from the fan 104 is such that the vented water vapour is not easily visible to the naked eye.

Infra-red sensors (not shown) located in the cavity 16 detect the presence of a user's hands in the cavity 16 and activate the drying mechanism of the hand dryer 10. Further, the control circuit for the piezo-electric device 102 is activated in readiness for evaporation and removal of deposited water.

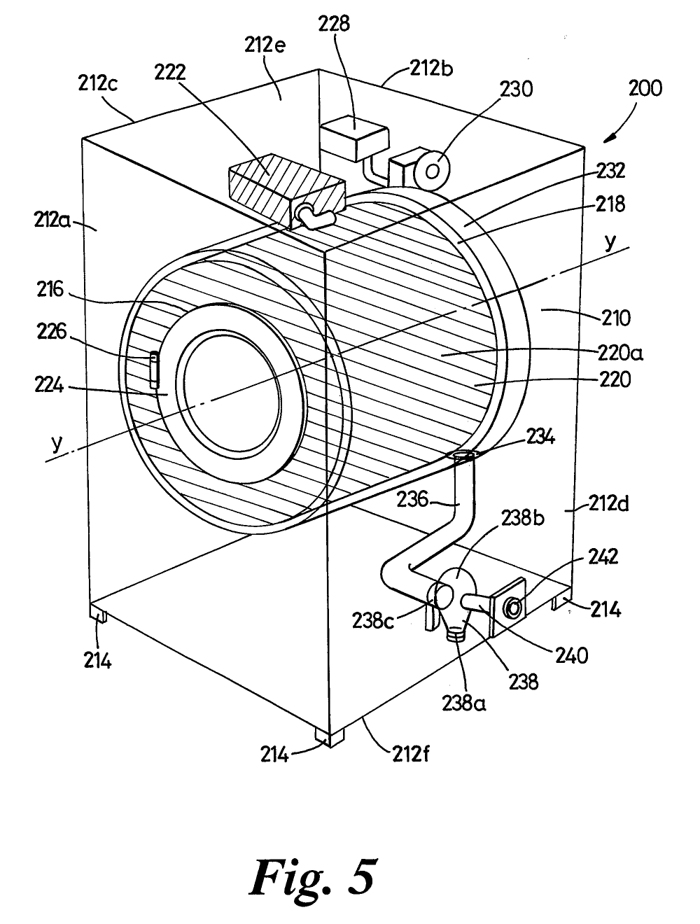

FIG. 5 illustrates a second embodiment of the present invention in the form of a laundry dryer 200. The laundry dryer 200 has an outer case 210 having a front wall 212a, a rear wall 212b, side walls 212c, 212d, an upper face 212e and a lower face 212f. The lower face 212f comprises supports 214 which support the laundry dryer 200 on a floor surface. These supports can take any suitable form, for example rubber feet or wheels. The front wall 212a of outer case 210 comprises a circular aperture 216 that allows access to a cavity 218. The cavity 218 is cylindrical in shape with a diameter wider than that of circular aperture 216. Disposed in the cavity 218 is a drum 220. The drum 220 is cylindrical in shape and is able to rotate about the horizontal axis Y-Y of cavity 218. Arrangements for rotatably mounting the drum 220 in cavity 218 are well known in the art, and will not be discussed any further here. The drum 220 includes a number of perforations in an outer wall 220a to allow gas or liquid to permeate through from the drum 220 into cavity 218. A motor drive 222 is disposed inside the outer casing 210 and extends into the cavity 218. A drive system, such as a belt or gearing, rotates the drum 220. This feature is not material to the present invention and so will not be discussed any further. However, it is clear that other forms of drive for the drum 220 could be contemplated.

Disposed in the front wall 212a is a door 224. The door 224 is attached to the front wall 212a through a hinged joint 226 which allows a user to swing open the door 224 to gain access to the inside of the drum 220. The door 224 may comprise a transparent panel, made from glass or a suitable high density plastic, which allows the contents of the drum 220 to be visible when the door 224 is closed.

The outer case 210 further comprises a heating element 228 which supplies thermal energy to generate heated air, and a fan 230 which blows the heated air into the cavity 218 to dry wet textiles present in the drum 220. Disposed at the rear of the cavity 218 is a condenser 232. The condenser 232 acts to condense water vapour generated by the action of heated air on the wet textiles in the drum 220. This dehumidifies the air inside the cavity 218. Condensed water vapour is then deposited in the lower region of the cavity 218.

Located in the lower region of the cavity 218 is the outlet 234. The outlet 234 acts to remove water generated by both the condenser 232. The outlet 234 also removes water extracted from the textiles by the spinning of the drum 220. Connected to the outlet 234 is a conduit 236 which conveys water downstream towards the liquid dispersion unit 238. The liquid dispersion unit 238 is substantially similar to the liquid dispersion unit 34 of the previous embodiment and comprises a piezo-electric device 238a mounted to the underside of collector 238b. A vent pipe 240 leads from the collector 238b to the outside of the outer case 210 via a grille 242. A fan 238c is provided to direct an airflow into the collector 238b.

In use, textiles to be dried are placed into the drum 220 through the circular aperture 216. The door 224 is closed and locked shut during use. The drum 220 is caused to spin by the operation of the motor drive 222. The drum 220 is able to spin at a variety of speeds, depending upon the user's requirements. The heating element 228 provides a source of heated air, and this air is conveyed into the cavity 218 (and therefore the drum 220) to dry the textiles within. The evaporated water vapour then passes into the condenser 232 and is condensed to a liquid state. The dried air is re-circulated back into the cavity 218 and the condensed water is supplied to the outlet 234 disposed at the lower end of the cavity 218. The condensed water then flows down the conduit 236 and enters the collector 238b.

The piezo-electric device 238a is then operated to evaporate the water in the collector 238b. When the collector 238b is full of water vapour, the fan 232c forces the evaporated water out of the collector 238b, via vent pipe 240, to be vented to the external environment through the grille 242. This process is repeated until all of the water contained within the collector 232b is removed.

The above embodiment allows waste water to be efficiently and easily removed from the laundry dryer 200 without the need for plumbing arrangements or repeated emptying of a water storage container. Further, because the exhausted water vapour has a lower temperature than the water vapour in the drum 220, there is little risk of injury to a user who comes into contact with the water vapour exhausted from the grille 242. The laundry dryer 200 according to the described embodiment therefore requires less maintenance, and is more safe and hygienic to operate.

It will be understood that the invention is not to be limited to the precise details of the embodiments described above. Other variations and modifications will be apparent to the skilled reader. For example, other forms of high frequency agitator could be contemplated, such as, for example, ultrasonic generators. These devices could be used in place of a piezo-electric device to agitate the water in the required manner.

The drain channel need not be exposed. For example, the drain channel could be located beneath a narrow aperture so that the drain channel is not visible externally. Alternatively, no drain channel need be present. The outlet could simply be formed in the lower end of the cavity. The outlet need not be in the form of a drain, nor need it comprise a plug or other blocking means. For example, the outlet could be in the form of a wide aperture, and may be suitable for receiving water vapour which is then condensed away from the cavity.

As a further variation, other forms of airflow generator are possible. For example, an air bleed or exhaust airflow could be taken from a motor unit. For example, in the case of the first embodiment of the invention, the motor unit for driving the drying process has a fan. This fan could be used to generate an airflow to vent the evaporated water to the outside of the drying apparatus rather than using an additional fan.

Additionally, the present invention need not be restricted to a hand dryer or a laundry dryer. Other forms of drying apparatus could be envisaged by the skilled reader, for example, other forms of domestic or commercial drying apparatus such as washer-dryers, ventilation-type laundry dryers or full-length body dryers.

1. A drying apparatus comprising:
an outer case, a portion of the outer case defining a cavity in which articles can be dried,
an outlet disposed at a lower end of the cavity,
a liquid dispersion unit comprising a collector downstream of the outlet and a liquid evaporation unit in communication with the collector and comprising a high frequency agitator.

2. The drying apparatus according to claim 1, further comprising an airflow generator for exhausting evaporated liquid from the collector to the exterior of the outer case.

3. The drying apparatus according to claim 1 or 2, wherein the liquid evaporation unit is attached to the collector.

4. The drying apparatus according to claim 1 or 2, wherein the high frequency agitator is electro-mechanical.

5. The drying apparatus according to claim 4, wherein the high frequency agitator is a piezoelectric device.

6. The drying apparatus according to claim 4, wherein the high frequency agitator is an ultrasonic generator.

7. The drying apparatus according to claim 1 or 2, further comprising a motor unit capable of performing a drying action on the articles to be dried.

8. The drying apparatus according to claim 1 or 2, wherein the airflow generator comprises a fan in communication with the collector.

9. The drying apparatus according to claim 8, wherein the fan is part of the motor unit.

10. The drying apparatus according to claim 1 or 2, wherein a drain channel is located at the lower end of the cavity, and the outlet is located in the drain channel.

11. The drying apparatus according to claim 1 or 2, wherein the drying apparatus is a hand dryer and the cavity is dimensioned to receive a user's hands.

12. The drying apparatus according to claim 1 or 2, wherein the drying apparatus is a laundry dryer and the cavity is dimensioned to receive textiles.

13. (canceled)
